(19) United States
(12) Patent Application Publication
(10) Pub. No.: US 2018/0372883 A1
(43) Pub. Date: Dec. 27, 2018

(54) Method And Terminal For Improving GPS Performance

(71) Applicant: HUAWEI TECHNOLOGIES CO., LTD., Shenzhen, Guangdong (CN)

(72) Inventors: Zhongying LONG, Shenzhen (CN); Shuhui SUN, Shenzhen (CN); Guangsheng PAN, Shenzhen (CN); Dingjie WANG, Shenzhen (CN); Wanji AN, Shenzhen (CN); Lina CHEN, Shenzhen (CN)

(21) Appl. No.: 15/775,435

(22) PCT Filed: Nov. 13, 2015
(86) PCT No.: PCT/CN2015/094552

§ 371 Date: May 11, 2018

(51) Int. Cl. G01S 19/26

(52) U.S. Cl. CPC G01S 19/26

(57) ABSTRACT

Embodiments of the present disclosure relate to methods and terminals for improving GPS performance. One example method includes detecting a placement state of the terminal and opening a receiving channel corresponding to the placement state. The receiving channel can be used to receive signals sent by K satellites. A signal receiving channel corresponding to the terminal is selected according to the state of the terminal.

### TECHNICAL FIELD

The present invention relates to the field of GPS applications, and in particular, to a method and a terminal for improving GPS performance.

### BACKGROUND

A global positioning system (Global Positioning System, GPS for short) has been widely applied to various fields. A GPS positioning function is even added to a wearable device. In particular, an arm wearable device has an increasingly high GPS performance requirement in multiple usage scenarios. However, a wearable device designed by using a conventional method is limited by antenna directivity, as shown in FIG. 1. FIG. 1 is a schematic diagram of antenna patterns when a single GPS antenna is placed in different states. Performance of the GPS antenna placed in a horizontal state and performance of the GPS antenna placed a vertical state are significantly different; that is, performance of the GPS antenna placed in the horizontal state is better than performance of the GPS antenna placed in the vertical state, or performance of the GPS antenna placed in the vertical state is better than performance of the GPS antenna placed in the horizontal state. Consequently, the GPS performance is significantly reduced. In addition, this brings much unnecessary trouble to a user.

### SUMMARY

Embodiments of the present invention provide a method and a terminal for improving GPS performance, so as to select, according to a state of the terminal, a signal receiving channel corresponding to the terminal, thereby achieving optimal GPS performance. When the state of the terminal is a second state, superimposition processing may be performed on a signal received when the terminal is in a horizontal state and a signal received when the terminal is in a vertical state. Further, when at least one third receiving channel is included, superimposition processing is simultaneously performed on signals received on multiple receiving channels, and an obtained signal is used as a signal received when the terminal is in the second state. In addition, an antenna phase or an external gain may be adjusted, so that strength of the received signal increases to maximize a gain of the received signal, thereby ensuring optimal GPS performance.

According to a first aspect, the present invention provides a method for improving GPS performance, and the method includes: first detecting a placement state of a terminal, and opening a receiving channel corresponding to the placement state, where the receiving channel is used to receive signals sent by K satellites, and each receiving channel includes an antenna used to receive the signals sent by the K satellites, where K is a positive integer.

With reference to the first aspect, in a first possible implementation of the first aspect, before the opening a receiving channel corresponding to the placement state, the method may further include: determining the receiving channel corresponding to the placement state.

With reference to the first possible implementation of the first aspect, in a second possible implementation of the first aspect, the determining the receiving channel corresponding to the placement state may be specifically as follows: opening multiple receiving channels to receive the signals sent by the K satellites; next, separately detecting quality of the signals that are sent by the K satellites and that are received on each receiving channel; then collecting statistics about signal reception quality of top H satellites with the highest signal reception quality that are on each receiving channel, and obtaining an average value of the signal reception quality of the top H satellites; and using a receiving channel that has a largest average value as the receiving channel corresponding to the placement state of the terminal, where H is a positive integer less than or equal to K.

With reference to the second possible implementation of the first aspect, in a third possible implementation of the first aspect, a measurement criterion for the quality of each of the signals sent by the K satellites is a carrier-to-noise ratio of the signal.

With reference to the first aspect, in a fourth possible implementation of the first aspect, the placement state is a first state, and the first state is a horizontal state or a vertical state.

With reference to the fourth possible implementation of the first aspect, in a fifth possible implementation of the first aspect, the placement state further includes a second state, where an angle of the second state is located in a plane determined by angles of the horizontal state and the vertical state and is different from an angle of the first state.

With reference to the fifth possible implementation of the first aspect, in a sixth possible implementation of the first aspect, when the placement state of the terminal is the second state, the opening a receiving channel corresponding to the second state may include:

opening a corresponding first receiving channel when the terminal is in the horizontal state and a corresponding second receiving channel when the terminal is in the vertical state, where the first receiving channel includes a first antenna, and the second receiving channel includes a second antenna.

In addition, the method includes: superimposing signals that are sent by the K satellites and that are received by using the first antenna and signals that are sent by the K satellites and that are received by using the second antenna, and using an obtained signal as a signal received when the terminal is in the second state.

With reference to the fifth possible implementation of the first aspect, in a seventh possible implementation of the first aspect, when the placement state of the terminal is the second state, the opening a receiving channel corresponding to the second state may include:

opening a corresponding first receiving channel when the terminal is in the horizontal state and a corresponding second receiving channel when the terminal is in the vertical state, and opening at least one third receiving channel, where the third receiving channel is corresponding to a stationary state other than the horizontal state and the vertical state, and the third receiving channel includes a third antenna.

In addition, the method includes: superimposing signals that are sent by the K satellites and that are received by using a first antenna, signals that are sent by the K satellites and that are received by using a second antenna, and signals that are sent by the K satellites and that are received by using the third antenna, and using an obtained signal as a signal received when the terminal is in the second state.

With reference to any one of the first aspect, or the first to the seventh possible implementations of the first aspect, in an eighth possible implementation of the first aspect, after the opening a receiving channel corresponding to the placement state, the method further includes: adjusting a phase of the antenna on the receiving channel.

With reference to any one of the first aspect, or the first to the seventh possible implementations of the first aspect, in a ninth possible implementation of the first aspect, when it is determined that a received signal gain of the receiving channel corresponding to the placement state of the terminal is less than a predetermined threshold, the method further includes: adjusting an external gain of the receiving channel.

According to a second aspect, the present invention provides a terminal for improving GPS performance, and the terminal includes:

a detection unit, configured to detect a placement state of the terminal; and

an opening unit, configured to open a receiving channel corresponding to the placement state, where the receiving channel is used to receive signals sent by K satellites, each receiving channel includes an antenna used to receive the signals sent by the K satellites, and K is a positive integer.

With reference to the second aspect, in a first possible implementation of the second aspect, the terminal further includes a processing unit, configured to determine the receiving channel corresponding to the placement state.

With reference to the first possible implementation of the second aspect, in a second possible implementation of the second aspect, the processing unit is specifically configured to: control the opening unit to open multiple receiving channels to receive the signals sent by the K satellites; next, separately detect quality of the signals that are sent by the K satellites and that are received on each receiving channel; then collect statistics about signal reception quality of top H satellites with the highest signal reception quality that are on each receiving channel, and obtain an average value of the signal reception quality of the top H satellites; and use a receiving channel that has a largest average value as the receiving channel corresponding to the placement state of the terminal, where H is a positive integer less than or equal to K.

With reference to the second possible implementation of the second aspect, in a third possible implementation of the second aspect, a measurement criterion for the quality of each of the signals sent by the K satellites is a carrier-to-noise ratio of the signal.

With reference to the second aspect, in a fourth possible implementation of the second aspect, the placement state is a first state, and the first state is a horizontal state or a vertical state.

With reference to the fourth possible implementation of the second aspect, in a fifth possible implementation of the second aspect, the placement state further includes a second state, where an angle of the second state is located in a plane determined by angles of the horizontal state and the vertical state and is different from an angle of the first state.

With reference to the fifth possible implementation of the second aspect, in a sixth possible implementation of the second aspect, the terminal further includes a signal superimposition unit;

when the detection unit detects that the placement state of the terminal is the second state, the opening unit opens a corresponding first receiving channel when the terminal is in the horizontal state and a corresponding second receiving channel when the terminal is in the vertical state, where the first receiving channel includes a first antenna, and the second receiving channel includes a second antenna; and

the signal superimposition unit superimposes signals that are sent by the K satellites and that are received by using the first antenna and signals that are sent by the K satellites and that are received by using the second antenna, and uses an obtained signal as a signal received when the terminal is in the second state.

With reference to the fifth possible implementation of the second aspect, in a seventh possible implementation of the second aspect, the terminal further includes a signal superimposition unit;

when the detection unit detects that the placement state of the terminal is the second state, the opening unit opens a corresponding first receiving channel when the terminal is in the horizontal state and a corresponding second receiving channel when the terminal is in the vertical state, and opens at least one third receiving channel, where the third receiving channel is corresponding to a stationary state other than the horizontal state and the vertical state, and the third receiving channel includes a third antenna; and the signal superimposition unit superimposes signals that are sent by the K satellites and that are received by using a first antenna, signals that are sent by the K satellites and that are received by using a second antenna, and signals that are sent by the K satellites and that are received by using the third antenna, and uses an obtained signal as a signal received when the terminal is in the second state.

With reference to any one of the second aspect, or the first to the seventh possible implementations of the second aspect, in an eighth possible implementation of the second aspect, the terminal further includes a phase adjustment unit, configured to adjust a phase of the antenna on the receiving channel.

With reference to any one of the second aspect, or the first to the seventh possible implementations of the second aspect, in a ninth possible implementation of the second aspect, the terminal further includes a gain adjustment unit, configured to adjust an external gain of the receiving channel.

According to a third aspect, the present invention provides a terminal for improving GPS performance, and the terminal includes:

a state sensor, configured to detect a placement state of the terminal; and

a switch, configured to open a receiving channel corresponding to the placement state, where the receiving channel is used to receive signals sent by K satellites, each receiving channel includes an antenna used to receive the signals sent by the K satellites, and K is a positive integer.

With reference to the third aspect, in a first possible implementation of the third aspect, the terminal further includes a processor, configured to determine the receiving channel corresponding to the placement state.

With reference to the first possible implementation of the third aspect, in a second possible implementation of the third aspect, the processor is specifically configured to:

control the switch to open multiple receiving channels to receive the signals sent by the K satellites; next, separately detect quality of the signals that are sent by the K satellites and that are received on each receiving channel; then collect statistics about signal reception quality of top H satellites with the highest signal reception quality that are on each receiving channel, and obtain an average value of the signal reception quality of the top H satellites; and use a receiving channel that has a largest average value as the receiving channel corresponding to the placement state of the terminal, where H is a positive integer less than or equal to K.

With reference to the second possible implementation of the third aspect, in a third possible implementation of the third aspect, a measurement criterion for the quality of each of the signals sent by the K satellites is a carrier-to-noise ratio of the signal.

With reference to the third aspect, in a fourth possible implementation of the third aspect, the placement state is a first state, and the first state is a horizontal state or a vertical state.

With reference to the fourth possible implementation of the third aspect, in a fifth possible implementation of the third aspect, the placement state further includes a second state, where an angle of the second state is located in a plane determined by angles of the horizontal state and the vertical state and is different from an angle of the first state.

With reference to the fifth possible implementation of the third aspect, in a sixth possible implementation of the third aspect, the terminal further includes a signal superimposer;

when the state sensor detects that the placement state of the terminal is the second state, the switch opens a corresponding first receiving channel when the terminal is in the horizontal state and a corresponding second receiving channel when the terminal is in the vertical state, where the first receiving channel includes a first antenna, and the second receiving channel includes a second antenna; and

the signal superimposer is configured to: superimpose signals that are sent by the K satellites and that are received by using the first antenna and signals that are sent by the K satellites and that are received by using the second antenna, and use an obtained signal as a signal received when the terminal is in the second state.

With reference to the fifth possible implementation of the third aspect, in a seventh possible implementation of the third aspect, the terminal further includes a signal superimposer;

when the state sensor detects that the placement state of the terminal is the second state, the switch opens a corresponding first receiving channel when the terminal is in the horizontal state and a corresponding second receiving channel when the terminal is in the vertical state, and opens at least one third receiving channel, where the third receiving channel is corresponding to a stationary state other than the horizontal state and the vertical state, and the third receiving channel includes a third antenna; and

the signal superimposer is configured to: superimpose signals that are sent by the K satellites and that are received by using a first antenna, signals that are sent by the K satellites and that are received by using a second antenna, and signals that are sent by the K satellites and that are received by using the third antenna, and use an obtained signal as a signal received when the terminal is in the second state.

With reference to any one of the third aspect, or the first to the seventh possible implementations of the third aspect, in an eighth possible implementation of the second aspect, the terminal further includes a phase shifter, configured to adjust a phase of the antenna on the receiving channel.

With reference to any one of the third aspect, or the first to the seventh possible implementations of the third aspect, in a ninth possible implementation of the second aspect, the terminal further includes a low noise amplifier, configured to adjust an external gain of the receiving channel.

Based on the foregoing technical solutions, according to the method for improving GPS performance provided in the embodiments of the present invention, a signal receiving channel corresponding to a terminal is selected according to a state of the terminal, thereby achieving optimal GPS performance. When the state of the terminal is a second state, superimposition processing may be performed on a signal received when the terminal is in a horizontal state and a signal received when the terminal is in a vertical state. Further, when at least one third receiving channel is included, superimposition processing is simultaneously performed on signals received on multiple receiving channels, and an obtained signal is used as a signal received when the terminal is in the second state, so that strength of the received signal increases to maximize a gain of the received signal, thereby ensuring optimal GPS performance.

### BRIEF DESCRIPTION OF DRAWINGS

FIG. 1 is a schematic diagram of antenna patterns of a single GPS antenna in different placement states in the prior art;

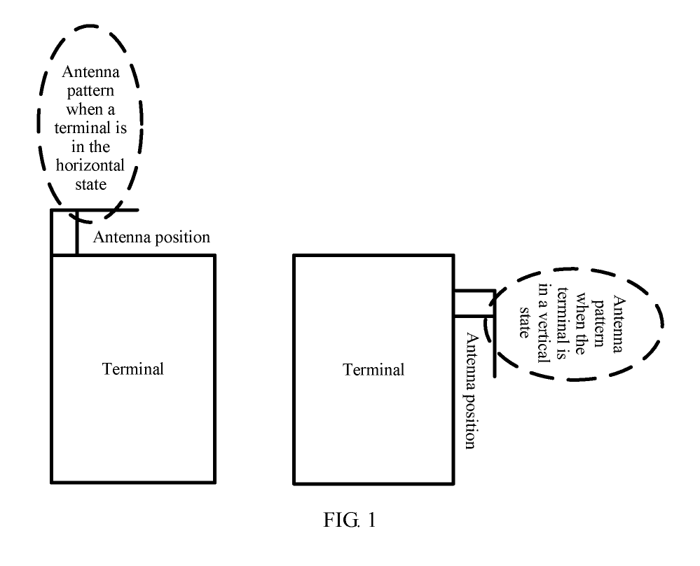

FIG. 2 is a flowchart of a method for improving GPS performance according to an embodiment of the present invention;

FIG. 3 is a schematic diagram of antenna patterns of multiple GPS antennas in different placement states in the present invention;

FIG. 4 is a structural block diagram of a terminal for improving GPS performance according to an embodiment of the present invention; and

FIG. 5 is a system architecture diagram of a terminal for improving GPS performance according to an embodiment of the present invention.

### DESCRIPTION OF EMBODIMENTS

The technical solutions of the present invention are further described in detail below with reference to accompanying drawings and embodiments.

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

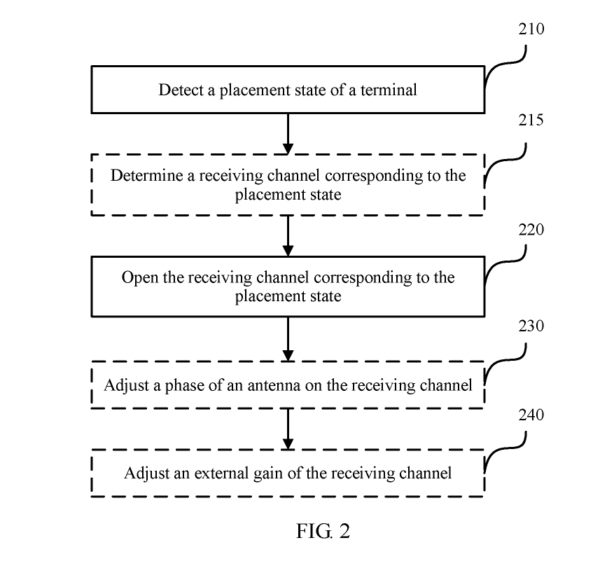

FIG. 2 is a flowchart of a method for improving GPS performance according to an embodiment of the present invention. As shown in FIG. 2, the method includes:
210. Detect a placement state of a terminal.

Specifically, the placement state of the terminal may include a first state. The first state may be a horizontal state or a vertical state.

It should be understood that there are many methods for detecting the placement state of the terminal. In this embodiment, that the state of the terminal is detected by using a state sensor is merely used as an example, and another manner is not limited.
220. Open a receiving channel corresponding to the placement state.

Specifically, the receiving channel is mainly used to receive signals sent by K satellites, and each receiving channel includes an antenna; that is, the receiving channel is used to receive, mainly by using the antenna, the signals sent by the K satellites, where K is a positive integer.

It should be understood that the receiving channel may be opened in many manners. A switch may be manually controlled to open the receiving channel, or a controller may be used to control opening of the receiving channel corresponding to the state of the terminal when the terminal is placed in a specific state. A specific implementation is not limited herein. The receiving channel herein may be considered as a transmission channel on which the signals sent by the K satellites are received by using the antenna until the signals are finally sent to a GPS receiver.

Optionally, before step 220, the method further includes step 215: determining the receiving channel corresponding to the placement state.

Specifically, multiple receiving channels are opened to receive the signals sent by the K satellites.

Generally, there are two receiving channels, that is, one is a corresponding receiving channel when the terminal is in the horizontal state, and the other is a receiving channel corresponding to the vertical state. However, there may be three receiving channels. A third receiving channel is a receiving channel corresponding to an angle other than the angle corresponding to the horizontal state or the vertical state. Only two receiving channels are first used as an example herein for description.

Quality of the signals that are sent by the K satellites and that are received on each of the two receiving channels is detected; statistics about signal reception quality of top H satellites with the highest signal reception quality that are on each of the two receiving channels are collected, and an average value of the signal reception quality of the top H satellites is obtained; and then a receiving channel that has a largest average value is determined as a receiving channel corresponding to a current placement state of the terminal, where H is a positive integer less than or equal to K.

It should be noted that a measurement criterion herein for quality of a signal sent by a satellite is a carrier-to-noise ratio of the signal. A larger ratio indicates higher signal reception quality, and a smaller ratio indicates lower signal reception quality.

It should be understood that, in an actual situation, because there may be some physical differences in signal receiving channels, the top H satellites that have the highest quality of the signals sent by the K satellites and that are on each receiving channel may not be several fixed satellites. For example, the top H satellites on a first channel are a satellite 1 to a satellite H, the top H satellites with the higher quality that are on a second channel are a satellite 5 to a satellite (H+5), and the top H satellites with the higher quality that are on another channel are different from those on the first channel and those on the second channel, where H is a positive integer less than or equal to K. Therefore, statistics about the quality of the signals that are sent by the K satellites and that are received on each receiving channel need to be collected to determine the signal reception quality of the top H satellites, and the average value of the signal reception quality of the top H satellites is obtained.

It should be further understood that the terminal may not need to perform this step again in subsequent operations after determining the receiving channel corresponding to the placement state of the terminal.

Further, optionally, the state of the terminal described in step 210 may actually include a second state.

An angle of the second state is located in a plane determined by angles of the horizontal state and the vertical state and is different from an angle of the first state.

When the state of the terminal is the second state, the opening a receiving channel corresponding to the second state includes: first opening a corresponding first receiving channel when the terminal is in the horizontal state and a corresponding second receiving channel when the terminal is in the vertical state, where the first receiving channel includes a first antenna, and the second receiving channel includes a second antenna.

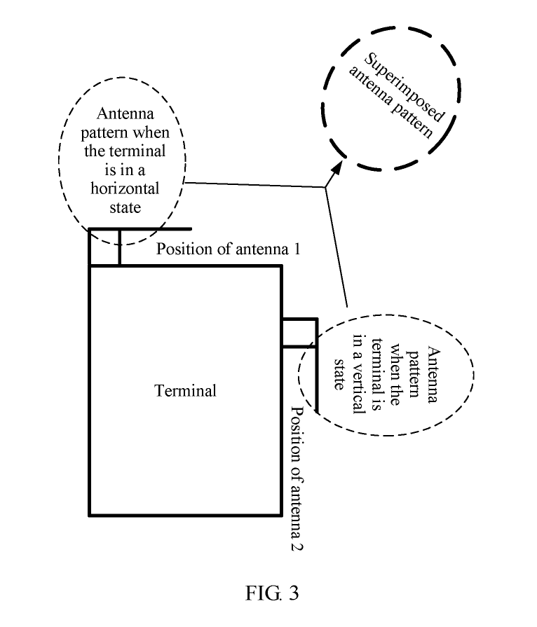

After superimposition processing is performed on signals that are sent by the K satellites and that are received by using the first antenna and signals that are sent by the K satellites and that are received by using the second antenna, an obtained signal is used as a signal received when the terminal is in the second state. Optionally, the superimposition processing herein may be as follows: Weighted superimposition processing is performed on signals received on the two receiving channels, and a processed signal is used as the signal received when the terminal is in the second state. Specifically, as shown in FIG. 3, FIG. 3 is a schematic diagram of antenna patterns of multiple GPS antennas in different placement states in the present invention. FIG. 3 shows an antenna pattern when the terminal is in the horizontal state, an antenna pattern when the terminal is in the vertical state, and an antenna pattern when the terminal is in the second state. The signal is obtained by superimposing signals received when the terminal is in the horizontal state and in the vertical state.

Further, optionally, when the placement state of the terminal is the second state, at least one third receiving channel may be included.

The opening a receiving channel corresponding to the second state includes:

opening a corresponding first receiving channel when the terminal is in the horizontal state and a corresponding second receiving channel when the terminal is in the vertical state, and opening the at least one third receiving channel, where the third receiving channel is corresponding to a stationary state other than the horizontal state and the vertical state, and the third receiving channel includes a third antenna.

After superimposition processing is performed on signals that are sent by the K satellites and that are received by using a first antenna, signals that are sent by the K satellites and that are received by using a second antenna, and signals that are sent by the K satellites and that are received by using the third antenna, an obtained signal may be used as a signal received when the terminal is in the second state.

It should be noted that when there are multiple third receiving channels, each receiving channel also includes an antenna, and the signal received when the terminal is in the second state is obtained by superimposing signals received on multiple channels (at least three channels). Similarly, superimposition processing herein may also be as follows: Weighted superimposition processing is performed on the signals received on the at least three receiving channels, and a processed signal is used as the signal received when the terminal is in the second state.

It should be noted herein that a state corresponding to the third receiving channel is a stationary state similar to the horizontal state or the vertical state, for example, an angle corresponding to the state is 50 degrees. That is, a signal received on the third receiving channel can only be a signal received when the terminal is in a state corresponding to an angle of 50 degrees. The second state described in the present invention includes states corresponding to multiple angles.

That is, a state when a terminal is at any angle may be obtained by superimposing signals received on a first receiving channel and a second receiving channel. However, when the terminal is at some specific angles, signal strength is relatively low after the signals received by using only the two receiving channels are superimposed. When at least one third receiving channel is further included, signal strength is enhanced after signals received by using multiple receiving channels are superimposed.

It should be noted that when the signals sent by the K satellites are received by using different receiving channels, the method further includes performing filtering processing on the signals received on each receiving channel, so as to enhance interference immunity of the signals.

It should be further understood that, in the foregoing method, when the terminal is placed in a specific state, a signal sent by a satellite is received by using a receiving channel corresponding to this state, but strength of the received signal may be not optimal. Therefore, after step 220, the method may further include step 230: adjusting a phase of the antenna on the receiving channel. The phase of the antenna used to receive a signal is adjusted to enhance strength of the received signal of the antenna on the receiving channel.

Further, when it is determined that a received signal gain of the receiving channel corresponding to the placement state of the terminal is less than a predetermined threshold, the method includes step 240: adjusting an external gain of the receiving channel.

A purpose of adjusting the external gain of the receiving channel is to maximize a sum of the received signal gain and the external gain that are of the receiving channel, thereby achieving optimal GPS performance. The received signal gain is obtained mainly by using a low noise amplifier (Low Noise Amplifier, LNA) inside each channel, and the external gain is adjusted by using a low noise amplifier outside each channel. A specific gain obtaining method and a specific gain adjustment method are prior arts, and details are not described herein.

In a specific example, to better describe content of this embodiment of the present invention, it is first assumed that K is 12, H is 5, and there are two signal receiving channels.

An example is used to first describe a method for detecting the state of the terminal and a method for determining the receiving channel corresponding to the state of the terminal.

A state sensor first detects the placement state of the terminal, for example, the placement state of the terminal is the horizontal state. A receiving channel corresponding to the horizontal state is opened, where the receiving channel includes an antenna, and the antenna may be used to receive signals sent by 12 satellites.

Before the opening a receiving channel corresponding to the horizontal state, the method further includes determining the receiving channel corresponding to the horizontal state.

Two receiving channels are separately opened first, and are both used to receive the signals sent by the 12 satellites. Then, quality of the signals that are sent by the 12 satellites and that are received on each receiving channel is detected, and the top 5 satellites with the highest signal reception quality that are on each receiving channel are determined. For example, satellites with the highest quality that are on a first channel are satellites 1, 3, 5, 7, and 10, and the top 5 satellites on a second receiving channel are satellites 2, 3, 6, 8, and 9. An average value of quality of signals that are sent by the top 5 satellites and that are received on each of the two receiving channels is obtained, and then a receiving channel that has a largest average value is determined as the receiving channel (for example, a receiving channel 1) corresponding to the horizontal state.

Similarly, a receiving channel (for example, a receiving channel 2) when the terminal is in the vertical state is determined in a same method.

When the terminal is in the second state, for example, when an angle of the terminal is 30°, the opening a receiving channel corresponding to the second state includes: opening the receiving channel when the terminal is in the horizontal state and the receiving channel when the terminal is in the vertical state, and performing corresponding weighted superimposition processing on signals that are sent by the 12 satellites and that are received by using a first antenna and signals that are sent by the 12 satellites and that are sent by using a second antenna, so as to obtain a signal received when the terminal is in the second state.

In another specific example, there are three signal receiving channels.

When the terminal is in the second state, for example, when an angle of the terminal is 135°, the opening a receiving channel corresponding to the second state includes: opening the receiving channel when the terminal is in the horizontal state and the receiving channel when the terminal is in the vertical state, and opening a third receiving channel, where the third receiving channel herein is corresponding to a stationary state other than the horizontal state and the vertical state. For example, a signal herein received on the third receiving channel is a signal received when the terminal is in a state corresponding to an angle of 50°. After a weighted summation is performed on signals received on the three receiving channels, an obtained signal is used as a signal received when the terminal is in the second state.

Further, filtering processing may be first performed on the foregoing signals received on the receiving channel, so as to enhance interference immunity of the signals.

When the terminal is in a specific state, and strength of the received signal is still relatively low, the phase of the antenna on the receiving channel corresponding to the state of the terminal may be adjusted, so that the strength of the received signal of the antenna on the receiving channel increases.

Further, when it is determined that a received signal gain of a receiving channel corresponding to a placement state of a terminal is less than a predetermined threshold, signal reception quality is too low to ensure a requirement of a user. In this case, an external LNA corresponding to a signal receiving channel corresponding to a current placement state of the terminal may be opened to dynamically adjust an external gain, so as to maximize a sum of a received signal gain of the channel corresponding to the current state of the terminal and the external gain of the receiving channel, thereby achieving optimal GPS performance. A specific adjustment process is a prior art, and details are not described herein.

It should be noted that the signals received on the receiving channel corresponding to the state of the terminal are finally sent to a GPS receiver for use by the user.

According to the method for improving GPS performance provided in this embodiment of the present invention, a signal receiving channel corresponding to a terminal is selected according to a state of the terminal, thereby achieving optimal GPS performance. When the state of the terminal is a second state, superimposition processing may be performed on a signal received when the terminal is in a horizontal state and a signal received when the terminal is in a vertical state. Further, when at least one third receiving channel is included, superimposition processing is simultaneously performed on signals received on multiple receiving channels, and an obtained signal is used as a signal received when the terminal is in the second state. In addition, an antenna phase or an external gain may be adjusted, so that strength of the received signal increases to maximize a gain of the received signal, thereby ensuring optimal GPS performance.

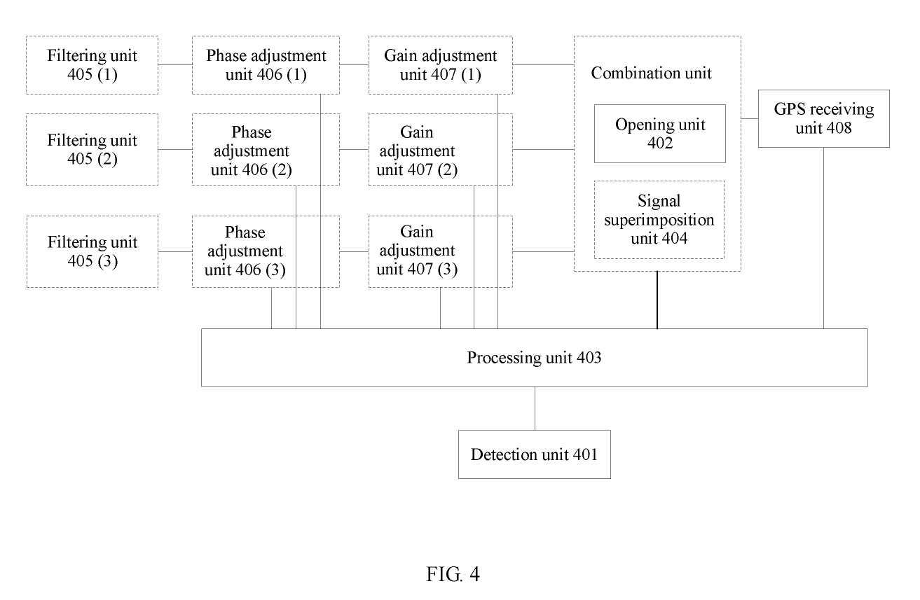

FIG. 4 is a structural block diagram of a terminal for improving GPS performance according to an embodiment of the present invention. As shown in FIG. 4, the terminal includes a detection unit 401 and an opening unit 402.

The detection unit 401 is configured to detect a placement state of the terminal.

Specifically, the placement state of the terminal may include a first state. The first state may be a horizontal state or a vertical state.

The opening unit 402 is configured to open a receiving channel corresponding to the placement state.

Specifically, the receiving channel is mainly used to receive signals sent by K satellites, and each receiving channel includes an antenna; that is, the receiving channel is used to receive, mainly by using the antenna, the signals sent by the K satellites, where K is a positive integer. The receiving channel herein may be considered as a transmission channel on which the signals sent by the K satellites are received by using the antenna until the signals are finally sent to a GPS receiver.

Optionally, the terminal may further include a processing unit 403, configured to determine the receiving channel corresponding to the placement state.

Specifically, before the opening unit 402 opens the receiving channel corresponding to the placement state, the processing unit 403 first determines the receiving channel corresponding to the placement state.

Specifically, the following step is performed: The processing unit 403 controls the opening unit 402 to open multiple receiving channels to receive the signals sent by the K satellites.

Generally, there are two receiving channels, that is, one is a corresponding receiving channel when the terminal is in the horizontal state, and the other is a receiving channel corresponding to the vertical state. However, there may be three receiving channels. A third receiving channel is a receiving channel corresponding to an angle other than the angle corresponding to the horizontal state or the vertical state. Only two receiving channels are first used as an example herein for description.

The processing unit 403 detects quality of the signals that are sent by the K satellites and that are received on each of the two receiving channels; collects statistics about signal reception quality of top H satellites with the highest signal reception quality that are on each of the two receiving channels, and obtains an average value of the signal reception quality of the top H satellites; and then determines a receiving channel that has a largest average value as a receiving channel corresponding to a current placement state of the terminal, where H is a positive integer less than or equal to K.

It should be noted that opening or closing by the opening unit 402 may be controlled manually or by using the processing unit.

It should be further noted that a measurement criterion herein for quality of a signal sent by a satellite is a carrier-to-noise ratio of the signal. A larger ratio indicates higher signal reception quality, and a smaller ratio indicates lower signal reception quality.

It should be understood that, in an actual situation, because there may be some physical differences in signal receiving channels, the top H satellites that have the highest quality of the signals sent by the K satellites and that are on each receiving channel may not be several fixed satellites. For example, the top H satellites on a first channel are a satellite 1 to a satellite H, the top H satellites with the highest quality that are on a second channel are a satellite 5 to a satellite (H+5), and the top H satellites with the highest quality that are on another channel are different from those on the first channel and those on the second channel, where H is a positive integer less than or equal to K. Therefore, the processing unit 403 needs to collect statistics about the quality of the signals that are sent by the K satellites and that are received on each receiving channel, to determine the signal reception quality of the top H satellites, and obtains the average value of the signal reception quality of the top H satellites.

It should be further understood that the processing unit 403 does not need to perform this step again in subsequent operations after determining the receiving channel corresponding to the placement state of the terminal.

Further, optionally, the state of the terminal may include a second state.

An angle of the second state is located in a plane determined by angles of the horizontal state and the vertical state and is different from an angle of the first state.

Optionally, the terminal may further include a signal superimposition unit 404. When the detection unit 401 detects that the state of the terminal is the second state, the opening unit 402 opens a corresponding first receiving channel when the terminal is in the horizontal state and a corresponding second receiving channel when the terminal is in the vertical state, where the first receiving channel includes a first antenna, and the second receiving channel includes a second antenna. The signal superimposition unit 404 superimposes signals that are sent by the K satellites and that are received by using the first antenna and signals that are sent by the K satellites and that are received by using the second antenna, and uses an obtained signal as a signal received when the terminal is in the second state.

Further, optionally, when the placement state of the terminal is the second state, at least one third receiving channel may be included. In this case, the opening unit 402 opens a corresponding first receiving channel when the terminal is in the horizontal state and a corresponding second receiving channel when the terminal is in the vertical state, and opens the at least one third receiving channel, where the third receiving channel includes a third antenna.

After performing superimposition processing on signals that are sent by the K satellites and that are received by using a first antenna, signals that are sent by the K satellites and that are received by using a second antenna, and signals that are sent by the K satellites and that are received by using the third antenna, the signal superimposition unit 404 uses an obtained signal as a signal received when the terminal is in the second state.

It should be noted that when there are multiple third receiving channels, each receiving channel also includes an antenna, and the signal received when the terminal is in the second state is obtained by superimposing signals received on multiple channels (at least three channels). Similarly, superimposition processing herein may also be as follows: Weighted superimposition processing is performed on the signals received on the at least three receiving channels, and a processed signal is used as the signal received when the terminal is in the second state.

It should be noted herein that a state corresponding to the third receiving channel is a stationary state similar to the horizontal state or the vertical state, for example, an angle corresponding to the state is 50 degrees. That is, a signal received on the third receiving channel can only be a signal received when the terminal is in a state corresponding to an angle of 50 degrees. The second state described in the present invention includes states corresponding to multiple angles.

That is, a state when a terminal is at any angle may be obtained by superimposing signals received on a first receiving channel and a second receiving channel. However, when the terminal is at some specific angles, signal strength is relatively low after the signals received by using only the two receiving channels are superimposed. When at least one third receiving channel is further included, signal strength is enhanced after signals received by using multiple receiving channels are superimposed.

In addition, the terminal may include a filtering processing unit 405, configured to filter for the foregoing signals that are sent by the K satellites and that are received on the receiving channel.

It should be understood that, in the foregoing method, when the terminal is placed in a specific state, a signal sent by a satellite is received by using a receiving channel corresponding to this state, but strength of the received signal may be not optimal. Therefore, the terminal may further include a phase shifting unit 406, configured to adjust a phase of the antenna on the receiving channel. The phase of the antenna used to receive a signal is adjusted to enhance strength of the received signal of the antenna on the receiving channel.

Further, the terminal may include a gain adjustment unit 407. When the processing unit 403 determines that a received signal gain of the receiving channel corresponding to the placement state of the terminal is less than a predetermined threshold, the gain adjustment unit adjusts an external gain of the receiving channel, so as to maximize a sum of the received signal gain and the external gain that are of the receiving channel, thereby achieving optimal GPS performance.

In a specific example, to better describe content of Embodiment 2 of the present invention, it is assumed that K is 12, H is 5, and there are two signal receiving channels.

An example is used to first describe the step in which the detection unit 401 detects the state of the terminal and the step in which the processing unit determines the receiving channel corresponding to the state of the terminal.

The detection unit 401 first detects the placement state of the terminal, for example, the placement state of the terminal is the horizontal state. The opening unit 402 opens a receiving channel corresponding to the horizontal state, where the receiving channel includes an antenna, and the antenna may be used to receive signals sent by 12 satellites.

Before the opening unit opens the receiving channel corresponding to the horizontal state, the processing unit 403 first determines the receiving channel corresponding to the horizontal state.

The processing unit first controls the opening unit to separately open two receiving channels, which are both used to receive the signals sent by the 12 satellites. Then, the processing unit detects quality of the signals that are sent by the 12 satellites and that are received on each receiving channel, and determines the top 5 satellites with the highest signal reception quality that are on each receiving channel. For example, satellites with the highest quality that are on a first channel are satellites 1, 3, 5, 7, and 10, and the top 5 satellites on a second receiving channel are satellites 2, 3, 6, 8, and 9. The processing unit obtains an average value of quality of signals that are sent by the top 5 satellites and that are received on each of the two receiving channels, and then determines a receiving channel that has a largest average value as the receiving channel (for example, a receiving channel 1) corresponding to the horizontal state.

Similarly, the processing unit 403 determines, in a same method, a receiving channel (for example, a receiving channel 2) when the terminal is in the vertical state.

When the detection unit 401 detects that the terminal is in the second state, for example, when the detection unit 401 detects that an angle of the terminal is 30°, the opening unit 402 opens the receiving channel when the terminal is in the horizontal state and the receiving channel when the terminal is in the vertical state, and the processing unit 403 performs corresponding weighted superimposition processing on signals that are sent by the 12 satellites and that are received by using a first antenna and signals that are sent by the 12 satellites and that are sent by using a second antenna, so as to obtain a signal received when the terminal is in the second state.

In another specific example, there are three signal receiving channels.

When the detection unit 401 detects that the terminal is in the second state, for example, when an angle of the terminal is 135°, the opening unit 402 opens the receiving channel when the terminal is in the horizontal state and the receiving channel when the terminal is in the vertical state, and opens a third receiving channel, where the third receiving channel herein is corresponding to a stationary state other than the horizontal state and the vertical state. For example, a signal herein received on the third receiving channel is a signal received when the terminal is in a state corresponding to an angle of 50°. After performing a weighted summation on signals received on the three receiving channels, the signal superimposition unit 404 uses an obtained signal as a signal received when the terminal is in the second state.

In addition, the filtering processing unit 405 may be used to filter for the foregoing signals that are sent by the K satellites and that are received on the receiving channel.

When the terminal is in a specific state, and strength of the received signal is still relatively low, the phase adjustment unit 406 may be used to adjust the phase of the antenna on the receiving channel corresponding to the state of the terminal, so that the strength of the received signal of the antenna on the receiving channel increases.

Further, when the processing unit 403 determines that a received signal gain of the receiving channel corresponding to the placement state of the terminal is less than a predetermined threshold, the gain adjustment unit 407 may be used to adjust an external gain, so as to maximize a sum of a received signal gain of a channel corresponding to a current state of the terminal and the external gain of the receiving channel, thereby achieving optimal GPS performance.

It should be noted that, if the terminal includes a filtering unit and/or a phase adjustment unit, and/or a gain adjustment unit, each channel includes a unit or a module that is in a one-to-one correspondence with each of the foregoing units. For example, each receiving channel in the terminal includes a filtering unit, or each receiving channel includes a gain adjustment unit. A specific structural block diagram of the terminal is shown in FIG. 4. In addition, the signals received on the receiving channel corresponding to the state of the terminal are finally sent to a GPS receiving unit 408 for use by a user.

According to the terminal for improving GPS performance provided in this embodiment of the present invention, a state detection unit is used to first detect a placement state of the terminal, and then a processing unit is used to determine a signal receiving channel corresponding to the terminal, thereby achieving optimal GPS performance. When the state of the terminal is a second state, the processing unit is further configured to perform superimposition processing on a signal received when the terminal is in a horizontal state and a signal received when the terminal is in a vertical state. Further, when at least one third receiving channel is included, the processing unit simultaneously performs superimposition processing on signals received on multiple receiving channels, and uses an obtained signal as a signal received when the terminal is in the second state. In addition, a phase adjustment unit may be used to adjust an antenna phase, or a gain adjustment unit may be used to adjust an external gain, so that strength of the received signal increases to maximize a gain of the received signal, thereby ensuring optimal GPS performance.

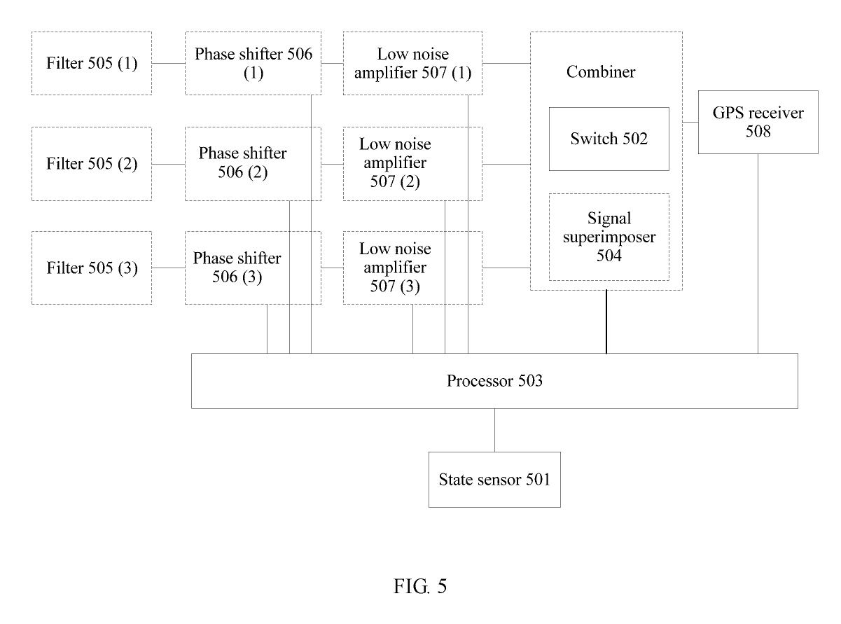

FIG. 5 is a system architecture diagram of a terminal for improving GPS performance according to an embodiment of the present invention. As shown in FIG. 5, the terminal includes a state sensor 501 and a switch 502.

The state sensor 501 is configured to detect a placement state of the terminal.

Specifically, the placement state of the terminal may include a first state. The first state may be a horizontal state or a vertical state.

The switch 502 is configured to open a receiving channel corresponding to the placement state.

Specifically, the receiving channel is mainly used to receive signals sent by K satellites, and each receiving channel includes an antenna used to receive the signals sent by the K satellites, where K is a positive integer. The receiving channel herein may be considered as a transmission channel on which the signals sent by the K satellites are received by using the antenna until the signals are finally sent to a GPS receiver.

Optionally, the terminal may further include a processor 503, configured to determine the receiving channel corresponding to the placement state.

Specifically, before the switch 502 opens the receiving channel corresponding to the placement state, the processor 503 first determines the receiving channel corresponding to the placement state.

Specifically, the following step is performed: The processor 503 controls the switch 502 to open multiple receiving channels to receive the signals sent by the K satellites.

Generally, there are two receiving channels, that is, one is a corresponding receiving channel when the terminal is in the horizontal state, and the other is a receiving channel corresponding to the vertical state. However, there may be three receiving channels. A third receiving channel is a receiving channel corresponding to an angle other than the angle corresponding to the horizontal state or the vertical state. Only two receiving channels are first used as an example herein for description.

The processor 503 detects quality of the signals that are sent by the K satellites and that are received on each of the two receiving channels; collects statistics about signal reception quality of top H satellites with the highest signal reception quality that are on each of the two receiving channels, and obtains an average value of the signal reception quality of the top H satellites; and then determines a receiving channel that has a largest average value as a receiving channel corresponding to a current placement state of the terminal, where H is a positive integer less than or equal to K.

It should be noted that opening or closing by the switch 502 may be controlled manually or by using the processor.

It should be further noted that a measurement criterion herein for quality of a signal sent by a satellite is a carrier-to-noise ratio of the signal. A larger ratio indicates higher signal reception quality, and a smaller ratio indicates lower signal reception quality.

It should be understood that, in an actual situation, because there may be some physical differences in signal receiving channels, the top H satellites that have the highest quality of the signals sent by the K satellites and that are on each receiving channel may not be several fixed satellites. For example, the top H satellites on a first channel are a satellite 1 to a satellite H, the top H satellites with the highest quality that are on a second channel are a satellite 5 to a satellite (H+5), and the top H satellites with the highest quality that are on another channel are different from those on the first channel and those on the second channel, where H is a positive integer less than or equal to K. Therefore, the processor 503 needs to collect statistics about the quality of the signals that are sent by the K satellites and that are received on each receiving channel, to determine the signal reception quality of the top H satellites, and obtains the average value of the signal reception quality of the top H satellites.

It should be further understood that the processor 503 does not need to perform this step again in subsequent operations after determining the receiving channel corresponding to the placement state of the terminal.

Further, optionally, the state of the terminal may include a second state.

An angle of the second state is located in a plane determined by angles of the horizontal state and the vertical state and is different from an angle of the first state.

The terminal may further include a signal superimposer 504, and the signal superimposer 504 and the switch 502 form a combiner. When the state sensor 501 detects that the state of the terminal is the second state, the switch 502 opens a corresponding first receiving channel when the terminal is in the horizontal state and a corresponding second receiving channel when the terminal is in the vertical state, where the first receiving channel includes a first antenna, and the second receiving channel includes a second antenna. The signal superimposer 504 superimposes signals that are sent by the K satellites and that are received by using the first antenna and signals that are sent by the K satellites and that are received by using the second antenna, and uses an obtained signal as a signal received when the terminal is in the second state.

Further, optionally, when the placement state of the terminal is the second state, at least one third receiving channel may be included. In this case, the switch 502 opens a corresponding first receiving channel when the terminal is in the horizontal state and a corresponding second receiving channel when the terminal is in the vertical state, and opens the at least one third receiving channel, where the third receiving channel includes a third antenna.

After performing superimposition processing on signals that are sent by the K satellites and that are received by using a first antenna, signals that are sent by the K satellites and that are received by using a second antenna, and signals that are sent by the K satellites and that are received by using the third antenna, the signal superimposer 504 uses an obtained signal as a signal received when the terminal is in the second state.

It should be noted that when there are multiple third receiving channels, each receiving channel also includes an antenna, and the signal received when the terminal is in the second state is obtained by superimposing signals received on multiple channels (at least three channels). Similarly, superimposition processing herein may also be as follows: Weighted superimposition processing is performed on the signals received on the at least three receiving channels, and a processed signal is used as the signal received when the terminal is in the second state.

It should be noted herein that a state corresponding to the third receiving channel is a stationary state similar to the horizontal state or the vertical state, for example, an angle corresponding to the state is 50 degrees. That is, a signal received on the third receiving channel can only be a signal received when the terminal is in a state corresponding to an angle of 50 degrees. The second state described in the present invention includes states corresponding to multiple angles.

That is, after superimposing signals received on a first receiving channel and a second receiving channel, the signal superimposer 504 may obtain a state when a terminal is at any angle. However, when the terminal is at some specific angles, signal strength is relatively low after the signals received by using only the two receiving channels are superimposed. When at least one third receiving channel is further included, signal strength is enhanced after signals received by using multiple receiving channels are superimposed.

In addition, the terminal may include a filter 505. The filter 505 is configured to filter for the foregoing signals that are sent by the K satellites and that are received on each receiving channel.

It should be understood that, in the foregoing method, when the terminal is placed in a specific state, a signal sent by a satellite is received by using a receiving channel corresponding to this state, but strength of the received signal may be not optimal. Therefore, the terminal may further include a phase shifter 506, configured to adjust a phase of the antenna on the receiving channel. The phase of the antenna used to receive a signal is adjusted to enhance strength of the received signal of the antenna on the receiving channel.

Further, the terminal may include a low noise amplifier 507. When the processor 503 determines that a received signal gain of the receiving channel corresponding to the placement state of the terminal is less than a predetermined threshold, the low noise amplifier 507 adjusts an external gain of the receiving channel, so as to maximize a sum of the received signal gain and the external gain that are of the receiving channel, thereby achieving optimal GPS performance.

It should be noted that the low noise amplifier mentioned herein is a low noise amplifier outside a channel instead of a low noise amplifier inside a channel.

In a specific example, to better describe content of Embodiment 2 of the present invention, it is assumed that K is 12, H is 5, and there are two signal receiving channels.

An example is used to first describe the step in which the state sensor 501 detects the state of the terminal and the step in which the processor 502 determines the receiving channel corresponding to the state of the terminal.

The state sensor 501 first detects the placement state of the terminal, for example, the placement state of the terminal is the horizontal state. The switch 502 opens a receiving channel corresponding to the horizontal state, where the receiving channel includes an antenna, and the antenna may be used to receive signals sent by 12 satellites.

Before the switch 502 opens the receiving channel corresponding to the horizontal state, the processor 503 first determines the receiving channel corresponding to the horizontal state.

The processor 503 controls the switch 502 to separately open two receiving channels, which are both used to receive the signals sent by the 12 satellites. Then, the processor 503 detects quality of the signals that are sent by the 12 satellites and that are received on each receiving channel, and determines the top 5 satellites with the highest signal reception quality that are on each receiving channel. For example, satellites with the highest quality that are on a first channel are satellites 1, 3, 5, 7, and 10, and the top 5 satellites on a second receiving channel are satellites 2, 3, 6, 8, and 9. The processor 503 obtains an average value of quality of signals that are sent by the top 5 satellites and that are received on each of the two receiving channels, and then determines a receiving channel that has a largest average value as the receiving channel (for example, a receiving channel 1) corresponding to the horizontal state.

Similarly, the processor 503 determines, in a same method, a receiving channel (for example, a receiving channel 2) when the terminal is in the vertical state.

When the state sensor 502 detects that the terminal is in the second state, for example, when the state sensor 502 detects that an angle of the terminal is 30°, the switch 502 opens the receiving channel when the terminal is in the horizontal state and the receiving channel when the terminal is in the vertical state, and the signal superimposer 504 performs corresponding weighted superimposition processing on signals that are sent by the 12 satellites and that are received by using a first antenna and signals that are sent by the 12 satellites and that are sent by using a second antenna, so as to obtain a signal received when the terminal is in the second state.

In another specific example, there are three signal receiving channels.

When the state sensor 501 detects that the terminal is in the second state, for example, when an angle of the terminal is 135°, the switch 502 opens the receiving channel when the terminal is in the horizontal state and the receiving channel when the terminal is in the vertical state, and opens a third receiving channel, where the third receiving channel herein is corresponding to a stationary state other than the horizontal state and the vertical state. For example, a signal herein received on the third receiving channel is a signal received when the terminal is in a state corresponding to an angle of 50°. After performing a weighted summation on signals received on the three receiving channels, the signal superimposer 504 uses an obtained signal as a signal received when the terminal is in the second state.

In addition, the filter 505 may be used to perform filtering processing on the foregoing signals received on the receiving channel, so as to enhance interference immunity of the signals.

When the terminal is in a specific state, and strength of the received signal is still relatively low, the phase shifter 506 may be used to adjust the phase of the antenna on the receiving channel corresponding to the state of the terminal, so that the strength of the received signal of the antenna on the receiving channel increases.

Further, when the processor 503 determines that a received signal gain of the receiving channel corresponding to the placement state of the terminal is less than a predetermined threshold, the low noise amplifier 507 may be used to adjust an external gain, so as to maximize a sum of a received signal gain of a channel corresponding to a current state of the terminal and the external gain of the receiving channel, thereby achieving optimal GPS performance.

It should be noted that the low noise amplifier 507 mentioned herein is a low noise amplifier outside a channel instead of a low noise amplifier inside a channel.

In addition, if the terminal includes a filter and/or a phase shifter, and/or a low noise amplifier, each receiving channel includes a device that is in a one-to-one correspondence with each of the foregoing devices. For example, each receiving channel includes a filter and/or a phase shifter. A specific system architecture is shown in FIG. 5.

The signals received on the receiving channel corresponding to the state of the terminal are finally sent to a GPS receiver 508 (as shown in FIG. 5) for use by the user.

According to the terminal for improving GPS performance provided in this embodiment of the present invention, a state sensor is used to first detect a placement state of the terminal, and then a processor is used to determine a signal receiving channel corresponding to the terminal, thereby achieving optimal GPS performance. When the state of the terminal is a second state, a signal superimposer is used to perform superimposition processing on a signal received when the terminal is in a horizontal state and a signal received when the terminal is in a vertical state. Further, when at least one third receiving channel is included, the signal superimposer simultaneously performs superimposition processing on signals received on multiple receiving channels, and uses an obtained signal as a signal received when the terminal is in the second state. In addition, a phase shifter may be used to adjust an antenna phase, or a low noise amplifier may be used to adjust an external gain, so that strength of the received signal increases to maximize a gain of the received signal, thereby ensuring optimal GPS performance.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementations, the objective, technical solutions, and benefits of the present invention are further described in detail. It should be understood that the foregoing descriptions are merely specific implementations of the present invention, but are not intended to limit the protection scope of the present invention. Any modification, equivalent replacement, or improvement made without departing from the spirit and principle of the present invention should fall within the protection scope of the present invention.

What is claimed is:

1-30. (canceled)

31. A method for improving GPS performance, wherein the method comprises:
detecting a placement state of a terminal; and
opening a receiving channel corresponding to the detected placement state, wherein the receiving channel is used to receive signals sent by K satellites, wherein the receiving channel comprises an antenna used to receive the signals sent by the K satellites, and wherein K is a positive integer.

32. The method according to claim 31, wherein before the opening a receiving channel corresponding to the detected placement state, the method further comprises: determining the receiving channel corresponding to the detected placement state.

33. The method according to claim 32, wherein the determining the receiving channel corresponding to the detected placement state comprises:
opening multiple receiving channels to receive the signals sent by the K satellites;
separately detecting quality of the signals sent by the K satellites and received on each receiving channel;
collecting statistics about signal reception quality of top H satellites with the highest signal reception quality on each receiving channel, wherein H is a positive integer less than or equal to K;
obtaining an average value of the signal reception quality of the top H satellites; and
determining a receiving channel that has a largest average value as the receiving channel corresponding to the detected placement state of the terminal.

34. The method according to claim 33, wherein a measurement criterion for the quality of each of the signals sent by the K satellites is a carrier-to-noise ratio of the signal.

35. The method according to claim 31, wherein the detected placement state is a first state, and the first state is a horizontal state or a vertical state.

36. The method according to claim 35, wherein the detected placement state further comprises a second state, and an angle of the second state is located in a plane determined by angles of the horizontal state and the vertical state and is different from an angle of the first state.

37. The method according to claim 36, wherein when the detected placement state of the terminal is the second state, the opening a receiving channel corresponding to the second state comprises:
opening a corresponding first receiving channel when the terminal is in the horizontal state and a corresponding second receiving channel when the terminal is in the vertical state, wherein the first receiving channel comprises a first antenna, and the second receiving channel comprises a second antenna; and
wherein the method further comprises:
superimposing signals sent by the K satellites and received by using the first antenna and signals sent by the K satellites and received by using the second antenna; and
using an obtained signal from the superimposing operation as a signal received when the terminal is in the second state.

38. The method according to claim 36, wherein when the detected placement state of the terminal is the second state, the opening a receiving channel corresponding to the second state comprises:
opening a corresponding first receiving channel when the terminal is in the horizontal state and a corresponding second receiving channel when the terminal is in the vertical state, and opening at least one third receiving channel, wherein the third receiving channel is corresponding to a stationary state other than the horizontal state and the vertical state, and wherein the first receiving channel comprises a first antenna, the second receiving channel comprises a second antenna, and the third receiving channel comprises a third antenna; and
wherein the method further comprises:
superimposing signals sent by the K satellites and received by using the first antenna, signals sent by the K satellites and received by using the second antenna, and signals sent by the K satellites and received by using the third antenna; and
using an obtained signal from the superimposing operation as a signal received when the terminal is in the second state.

39. The method according to claim 31, wherein after the opening a receiving channel corresponding to the detected placement state, the method further comprises:
adjusting a phase of the antenna on the receiving channel.

40. The method according to claim 31, wherein in response to determining that a received signal gain of the receiving channel corresponding to the detected placement state of the terminal is less than a predetermined threshold, the method further comprises:
adjusting an external gain of the receiving channel.

41. A terminal, wherein the terminal comprises:
a state sensor, the state sensor configured to detect a placement state of the terminal; and
a switch, the switch configured to open a receiving channel corresponding to the detected placement state, wherein the receiving channel is used to receive signals sent by K satellites, wherein the receiving channel comprises an antenna used to receive the signals sent by the K satellites, and wherein K is a positive integer.

42. The terminal according to claim 41, wherein the terminal further comprises at least one processor, the at least one processor operable to execute instructions to determine the receiving channel corresponding to the detected placement state.

43. The terminal according to claim 42, wherein the at least one processor is operable to execute instructions to:
control the switch to open multiple receiving channels to receive the signals sent by the K satellites;
separately detect quality of the signals sent by the K satellites and received on each receiving channel;
collect statistics about signal reception quality of top H satellites with the highest signal reception quality that are on each receiving channel, wherein H is a positive integer less than or equal to K;
obtain an average value of the signal reception quality of the top H satellites; and
determine a receiving channel that has a largest average value as the receiving channel corresponding to the detected placement state of the terminal.

44. The terminal according to claim 43, wherein a measurement criterion for the quality of each of the signals sent by the K satellites is a carrier-to-noise ratio of the signal.

45. The terminal according to claim 41, wherein the detected placement state is a first state, and wherein the first state is a horizontal state or a vertical state.

46. The terminal according to claim 45, wherein the detected placement state further comprises a second state, and wherein an angle of the second state is located in a plane determined by angles of the horizontal state and the vertical state and is different from an angle of the first state.

47. The terminal according to claim 46, wherein the terminal further comprises a signal superimposer;
when the state sensor detects that the detected placement state of the terminal is the second state, the switch is configured to open a corresponding first receiving channel when the terminal is in the horizontal state and a corresponding second receiving channel when the terminal is in the vertical state, wherein the first receiving channel comprises a first antenna, and the second receiving channel comprises a second antenna; and
the signal superimposer is configured to:
superimpose signals sent by the K satellites and received by using the first antenna and signals sent by the K satellites and received by using the second antenna and
use an obtained signal from the superimposing operation as a signal received when the terminal is in the second state.

48. The terminal according to claim 46, wherein the terminal further comprises a signal superimposer;
when the state sensor detects that the detected placement state of the terminal is the second state, the switch is configured to:
open a corresponding first receiving channel when the terminal is in the horizontal state and a corresponding second receiving channel when the terminal is in the vertical state; and
open at least one third receiving channel, wherein the third receiving channel is corresponding to a stationary state other than the horizontal state and the vertical state, and wherein the first receiving channel comprises a first antenna, and the second receiving channel comprises a second antenna, and the third receiving channel comprises a third antenna; and
the signal superimposer is configured to:
superimpose signals sent by the K satellites and received by using the first antenna, signals sent by the K satellites and received by using the second antenna and signals sent by the K satellites and received by using the third antenna, and
use an obtained signal from the superimposing operation as a signal received when the terminal is in the second state.

49. The terminal according to claim 41, wherein the terminal further comprises a phase shifter, the phase shifter configured to adjust a phase of the antenna on the receiving channel.

50. The terminal according to claim 41, wherein the terminal further comprises a low noise amplifier, the low noise amplifier configured to adjust an external gain of the receiving channel.
